(19) United States
(12) Patent Application Publication
(10) Pub. No.: US 2010/0065490 A1
(43) Pub. Date: Mar. 18, 2010

(54) ION-PERMEABLE MEMBRANE AND THE PRODUCTION THEREOF

(75) Inventors: Jörg Henning Balster, Enschede (NL); Dimitrios Stamatialis, Enschede (NL); Matthias Wessling, Enschede (NL)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Fuma-Tech Gesellschaft fur funktionelle Membranen und Anlagentechnologie mbH, St. Ingbert (DE)

(21) Appl. No.: 12/595,269

(22) PCT Filed: Apr. 10, 2008
(86) PCT No.: PCT/EP08/02832

§ 371 Date: Nov. 24, 2009

(30) Foreign Application Priority Data
Apr. 10, 2007 (EP) 07007302.8

(51) Int. Cl. B01D 61/28; B32B 3/30; C25B 9/00; B01J 19/00; B01D 67/00; B29C 71/00; B01D 71/68; B29C 59/02; B29C 41/08

(52) U.S. Cl. 210/483; 428/156; 428/172; 204/279; 422/310; 205/770; 264/293; 264/236; 264/309

(57) ABSTRACT

A method for producing an ion-permeable membrane which has at least one profiled surface includes contacting a shaping element with an uncured polymer film which contains at least one polymer, impressing the shaping element onto the polymer film and generating a regular pattern of identically or differently structured elevations and/or recesses on the polymer film.

### RELATED APPLICATIONS

This is a §371 of International Application No. PCT/EP2008/002832, with an inter-national filing date of Apr. 10, 2009 (WO 2008/122442 A1, published Oct. 16, 2008), which is based on European Patent Application No. 07007302.8, filed Apr. 10, 2007.

### TECHNICAL FIELD

This disclosure relates to a method of production of an ion-permeable membrane having a profiled surface, to an ion-permeable membrane which is producible, in particular by such a method, to a membrane arrangement which comprises at least one such ion-permeable membrane, and to a method for the electrodialytic desalting of liquids, in which method at least one such membrane arrangement is used.

### BACKGROUND

Methods for desalting liquids such as, e.g., water are of great industrial importance. By way of example, mention may be made of drinking water isolation and also the production of high-purity process waters for industry. Known methods for desalting include, in particular, ion-exchange methods, reverse osmosis and electrochemical membrane processes. Among the latter, in particular, electrodialysis may be emphasized, in which ion-exchange membranes are used in combination with an electrical potential difference to separate off ionic species from solvents.

In a customary electrodialysis device, anion and cation exchange membranes are arranged alternately between two electrodes, in particular, in a stack-like manner or wound. Neighboring ion-exchange membranes form separate “chambers” through which a liquid which is to be de-salted can be passed. Larger systems can comprise several hundred of these chambers. If a direct electrical current is applied to the electrodes, anions which are present in the liquid migrate in the direction of the anode. The anions can pass through positively charged anion-exchange membranes, but are stopped at the next respective negatively charged cation-exchange membrane. Cations present in the liquid behave in a similar manner, but with reverse sign. Correspondingly, salts accumulate in one half of the chambers, while the liquid is depleted in salt in the remaining chambers. Chambers in which the concentration of salts increases are called concentrate chambers, and the others diluate chambers. The liquid flowing through the respective chambers is correspondingly termed concentrate or diluate, respectively.

As a rule, spacers are arranged between the ion-exchange membranes. These spacers firstly have the function of mechanical stabilizers which ensure a defined spacing of the ion-exchange membranes from one another. Secondly, they form barriers for the liquid flowing through the chambers and generate turbulence, which can counteract the polarization phenomena. However, classic spacers as a rule have no ionic conductivity and therefore increase the total electrical resistance of a series of ion-exchange membranes.

The production of ion-conducting spacers is possible in principle, but, owing to the necessary chemical modifications, the production costs thereof are very much higher than the comparable non-conducting variants. Alternatively, attempts have already been made to replace the classic spacers by ion-exchange particles which, as a consequence of the swelling properties of such particles, however, was likewise accompanied by problems.

A very interesting approach to the solution of those problems may be found in WO 2005/009596, in which a membrane arrangement is described for continuous electrodialytic desalting. This comprises at least one cation-exchange and anion-exchange membrane arranged in parallel, wherein the surfaces of the membranes have, in each case, at least in regions on the mutually facing surface side or on both surface sides a regular pattern of identically or differently shaped elevations and/or recesses. The recesses between the elevations form channels and the membranes are in contact with one another in regions via the elevations which are arranged on their surfaces with formation of corresponding contact points. Between these contact points, in this manner, a continuously branching channel system is formed through which diluate and/or concentrate can flow. In conventional membrane arrangements, separate spacers are used therefor. These are correspondingly no longer required in the described membrane arrangement, by which means the above-described problems no longer occur.

The membranes described in WO 2005/009596 which are provided with elevations and recesses are produced by embossing, pressing or rolling thermoplastically deformable membranes. These have a thermoplastic matrix into which ion-conducting additives are embedded. The embedding, pressing or rolling, however, requires a corresponding tool and also, for the desired structure, appropriate inverse profiles and is associated with corresponding consumption of time.

It could therefore be helpful to provide ion-permeable membranes, in particular, ion-exchange membranes, which have a profiled surface as do the membranes known from WO 2005/009596. In membrane arrangements of electrodialysis devices, they should also be able to be used even without a separate spacer. The ion-permeable membranes, however, should be comparatively simpler and cheaper to produce.

### SUMMARY

We provide a method for producing an ion-permeable membrane which has at least one profiled surface including contacting a shaping element with an uncured polymer film which contains at least one polymer, impressing the shaping element onto the polymer film, and generating a regular pattern of identically or differently structured elevations and/or recesses on the polymer film.

We also provide an ion-permeable membrane having a profiled surface, produced by the method.

We further provide a membrane arrangement comprising at least one ion-permeable membrane.

We further still provide a method for electrodialytic desalting of liquids including passing the liquids through at least one membrane arrangement.

### BRIEF DESCRIPTION OF THE DRAWINGS

Further features result from the description hereinafter of representative examples. In this case, the individual features in each case alone or in combination as a plurality with one anther can be implemented. The representative examples described only serve for explanation and better understanding and are in no way to be taken as limiting.

In the figures:

FIGS. 1A-1D show spacers suitable as shaping elements which are known. The spacers are described by Balster et al. (Journal of Membrane Science, 282, 2006, 351-361). The spacers A, B, C and D are in the form of grid-like flat structures made of filaments.

FIGS. 2A-2B show a photo of the polymer layer of an ion-exchange membrane from the bottom 2A and also an enlarged detail of a top part region from 2B.

FIG. 3 is a graph illustrating the course of the limiting current density as a function of throughflow in an electrodialysis operation, in each case determined for a membrane arrangement having an ion-exchange membrane (top) and a non-profiled standard membrane (bottom).

FIG. 4 shows diagrammatically the procedure in one of our methods.

### DETAILED DESCRIPTION

A method for production of an ion-permeable membrane, in particular, an ion-exchange membrane, which has at least one profiled surface, is distinguished in particular in that a shaping element is brought into contact with an uncured polymer film which contains at least one polymer, in particular is impressed onto this polymer film, generating a preferably regular pattern of identically or differently structured elevations and/or recesses.

In contrast to the procedure from WO 2005/009596, according to our “ready-to-use,” cured membranes, and therefore membranes which are only plastically deformable at high temperatures, are not used as a starting point in the production of a profiled ion-permeable membrane. Our methods, instead, makes use of uncured polymer films which are, in particular, intermediate products occurring in the production of membranes. In other words, in the context of our methods, instead, of cured polymer films, use is made of precursors of such polymer films, which should be taken to mean, in particular, all single-component or multi-component systems from which compounds having a polymeric structure can be produced. The usable precursors can comprise not only reactive individual monomers, but also precrosslinked monomer components. The membrane is profiled in particular previously in the context of its production process (the expression “profiling” in the context of this application is to be taken to mean generating the above-mentioned, preferably regular, pattern of identically or differently structured elevations and/or recesses on the uncured polymer film containing at least one polymer). There is no complex downstream processing of the membrane.

Preferably, the method comprises a plurality of steps. In one step the uncured polymer film is provided on a substrate, in a further step the shaping element is brought into contact with the uncured polymer film, and in a third step the polymer film is cured and converted into a cured polymer layer.

The advantages of this procedure are obvious. Firstly, an uncured polymer film can be profiled very much more readily than a cured film. Secondly, the profiling can proceed at room temperature. Hot press molding or hot embossing is not necessary and also not preferred. Correspondingly, the material selection for the membrane is also no longer necessarily restricted to thermally deformable polymers.

Particularly preferably, the shaping element is brought into contact with a solvent- and/or dispersant-containing polymer film in which the at least one polymer is present at least in part in dissolved and/or dispersed form. Therefore, as uncured polymer film use is preferably made of a solvent- and/or dispersant-containing film.

The fraction of solvent and/or dispersant in the film's case is preferably between 30% by weight and 95% by weight, in particular between 50% by weight and 90% by weight.

As indicated above, it is also possible that, as uncured polymer film, use is made of a film which, alternatively or additionally to the solvent and/or the dispersant, comprises at least one crosslinkable component such as, for example, a monomer fraction. Preferably, the crosslinkable component is a component which is crosslinkable by radiation and/or thermally.

Contacting the shaping element with the uncured polymer film preferably proceeds by impressing, in particular, at only a slight pressure. Thus, the shaping element can also only be laid onto the polymer film such that it is merely pressed into the polymer film by its own weight. It is preferred to be arranged in such a manner to the polymer film that it only lightly touches the surface of the polymer film.

For provision of the uncured polymer film, it is preferably applied to the substrate in free-flowing, pourable and/or sprayable form. The application proceeds as a function of the consistency of the polymer film, correspondingly preferably by pouring, spreading or spraying.

As a shaping element, in principle any body, in particular any flat or round body which possesses a profile corresponding to the desired pattern, comes into consideration. By way of example, mention may be made of punches or profiled rollers.

Preferably, as a shaping element, a grid-like or lattice-like flat structure made of filaments is pressed onto the polymer film. The filaments in this case are preferably arranged crossed and thus form mesh-like passages. The passages are preferably formed in the shape of a parallelogram, in particular, rhomboidal, particularly preferably essentially square. Filaments orientated in the same direction preferably proceed in each case strictly parallel to one another and are arranged in preferably regular intervals from one another. Crossing filaments preferably make an angle between 60° and 120°, in particular of approximately 90°.

The filaments can have a round and/or a polygonal cross section. As shaping elements, structures made of filaments are usable which comprise not only filaments having a round cross section but also filaments having a polygonal cross section.

The filaments preferably have a diameter between 0.3 mm and 2 mm, in particular, between 0.5 mm and 1.2 mm, particularly preferably of approximately 0.8 mm. The side lengths of the passages which are constructed in a parallelogram-like manner are preferably between 1 mm and 10 mm, in particular, between 3 mm and 8 mm, particularly preferably approximately 5 mm.

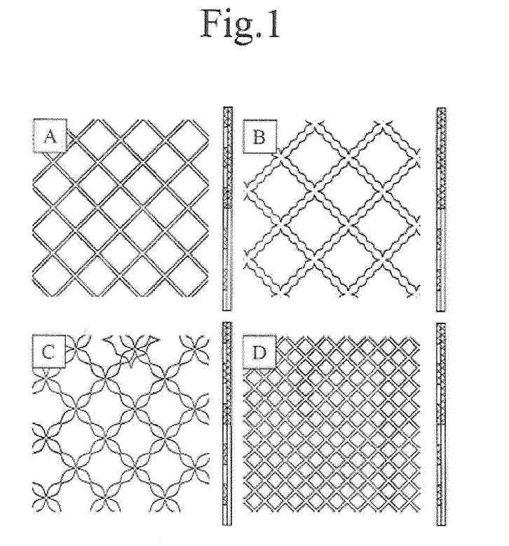

As a shaping element, use may be made of commercially available spacers. Suitable spacers have been described, for example, by Balster et al. (Journal of Membrane Science, 282, 2006, 351-361) and are pictured in FIG. 1. As may be seen on the basis of FIG. 1 (spacer A, B, C and D), the spacers depicted are present in the form of grid-like or lattice-like flat structures made of filaments, as have already been described above.

It is preferred that the shaping element remains in contact with the polymer film until the polymer film is essentially completely cured. Preferably, the shaping element is not detached from the cured polymer film until after the curing.

It is further preferred that the shaping element is contacted with the uncured polymer film at room temperature. The uncured polymer film is correspondingly preferably not, for instance, a melt. Preferably, heat is not fed to either the shaping element or the polymer film during or before contacting.

Preferably, the polymer film is cured by removing solvent and/or dispersant present in the polymer film. For this, in the simplest case, the solvent and/or the dispersant can simply be allowed to evaporate. The evaporation may of course also be actively accelerated, for example by aeration.

It may also be preferred for the polymer film to cure under phase-inverting conditions. For this, a polymer film which comprises a solvent in which the at least one polymer is at least in part dissolved (preferably an organic solvent, for example N-methyl-2-pyrrolidone), can be brought into contact with a liquid medium in which the at least one polymer is essentially insoluble (for example water) but which is miscible at least in part with the solvent in the polymer film. At the phase boundary between the solvent-containing polymer film and the liquid medium, solvent and liquid medium mix and the at least one polymer precipitates. In the interior of the polymer film this process (precipitation) does not start simultaneously, since the liquid medium can only penetrate into the polymer film with a certain delay. In this manner, profiled cured polymer films may be generated which, in the interior, have a higher porosity than at the surface thereof.

If the uncured polymer film comprises at least one crosslinkable component, it is also possible that the polymer film, for curing, is irradiated, for example with UV radiation or electron radiation. If the polymer film comprises a thermally crosslinkable component, the film may be cured by heat supply.

It is preferred that the polymer film, at least in the cured state, comprises ion-conducting, in particular proton-conducting, properties. In principle, the polymer film can have cation-conducting or anion-conducting properties. The polymer film can comprise ion-conducting additives.

The uncured polymer film should not be provided on a desired substrate, but on a polymeric support layer.

Preferably, a support layer is used which can participate in a firm bond with the uncured polymer film, in such a manner that the polymer film, after curing, cannot be detached from the support layer, at least no longer in a nondestructive manner. For example, the polymeric support layer can be selected in such a manner that it can be solubilized by the solvent present in the polymer film, in such a manner that the support layer and the polymer film join one another in such a manner that an interface between the two is no longer determinable.

Particularly preferably, use is made of a support layer, the material composition of which essentially corresponds to that of the polymer film after curing. Reference is hereby made to the corresponding details on the composition of the polymer film (see above).

Particularly preferably, a previously profiled and cured polymer film can also be used as a support layer. A further polymer film can be applied to the non-profiled side thereof. In this manner, polymer layers which are profiled on both sides may be produced.

In this manner a polymer layer made of an anion-exchange material can be combined with a polymer layer made of a cation-exchange material and, as a result, a bipolar membrane can be obtained. For instance, for example, a polymer layer profiled on one side and made of an anion-exchange material can be produced by our method and, on the non-profiled side thereof, subsequently a polymer film made of a cation-exchange material can be applied, profiled and cured (or vice versa).

As does the polymer film, the support layer may also comprise ion-conducting, in particular, proton-conducting, properties.

Our method may comprise at least the following steps:
(1) applying a solvent- and/or dispersant-containing polymer film in which at least one polymer is present at least in part in dissolved and/or dispersed form, to a polymeric support layer,
(2) contacting a shaping element with the polymer film, generating a preferably regular pattern of identically or differently structured elevations and/or recesses and
(3) removal of solvent and/or dispersant present in the polymer film.

The shaping element is preferably brought into contact with a polymer film which has a thickness between 50 μm and 500 μm, preferably of approximately 300 μm. If the shaping element is brought into contact with a polymer film which was not applied to a polymeric support layer, then it is preferred that the thickness of the polymer film is not less than 100 μm. These details all relate to the as yet uncured, preferably solvent-containing, film. The layer resulting after curing is generally significantly thinner.

The thickness of the polymeric support layer onto which the uncured polymer film is provided is preferably between 10 μm and 300 μm, in particular, approximately 100 μm. These details relate to a cured, preferably completely solvent-free, layer.

As uncured polymer film, preferably use is made of a film which comprises a mixture of two or more polymers.

At this point it is useful briefly to consider the expression “polymer.” The expression “polymer” means that it comprises not only polymers which have resulted from one type of monomer, but also those which have been formed from two or more types of monomer. It therefore also comprises copolymers.

Particularly preferably, the uncured polymer film comprises a sulfonated polyether ether ketone (SPEEK) and/or a polyether sulfone (PES).

In addition, it is preferred that the uncured polymer film comprises at least one organic solvent, in particular N-methylpyrrolidone (NMP).

The shaping element may be brought into contact with a polymer film which comprises the at least one polymer in a fraction of between 5% by weight and 60% by weight, preferably between 10% by weight and 40% by weight, in particular between 10% by weight and 30% by weight.

It is particularly readily possible to replicate the structure of a suitable shaping element on the polymer film, and so obtain not for instance an inverse structure (as is generally the case, in particular, in the case of a firm impression), but essentially a copy of the profile developed on the shaping element. Particularly suitable therefor are the above-described grid-like or lattice-like flat structures made of filaments, in particular the above-described commercial spacers. If such a structure is brought into contact as shaping element with the polymer film, in particular in such a manner that it only lightly touches the surface of the polymer film, then, presumably due to capillary forces, the at least one polymer can collect on and/or under the filaments. At the latest, if the polymer fraction, for example due to evaporation of the solvent, exceeds 40% by weight in the polymer film, this process is generally brought to a standstill owing to the increasing viscosity of the polymer film. If the free-flowing nature of the polymer film is maintained over a sufficiently long time, then the copy which is mentioned of the shaping element is obtained.

As has already been mentioned at the outset, we provide ion-permeable membranes, in particular ion-exchange membranes, having a profiled surface, in particular ion-conducting membranes, which are produced or producible by our method.

An ion-permeable membrane is distinguished in particular in that it comprises a polymer layer having a preferably regular pattern of identically or differently structured elevations and/or recesses.

Preferably, an ion-permeable membrane comprises a polymeric support layer on which the polymer layer having the preferably regular pattern of identically or differently structured elevations and/or recesses is arranged.

The ion-permeable membrane can also comprise two polymer layers which are joined to one another, each of which, on the side facing away from the other, comprises a preferably regular pattern of identically or differently structured elevations and/or recesses. The two polymer layers are likewise joined to one another via a support layer which is arranged between the two polymer layers.

The patterns can differ from one another on the two sides.

An ion-permeable membrane may comprise one polymer layer made of a cation-exchange material and a second made of an anion-exchange material. In these cases the ion-permeable membrane has bipolar properties.

Particular preference can also be given to ion-permeable membranes having a polymer layer which comprises on both sides a preferably regular pattern of identically or differently structured elevations and/or recesses.

The profiled polymer layer in an ion-permeable membrane preferably corresponds in all properties thereof, in particular in the composition thereof, to the polymer layer which is obtained by curing the uncured polymer film by our method, which has already been described above. Reference is hereby explicitly made to the corresponding details.

Preferably, the polymer layer, in an ion-exchange membrane, has a thickness between 10 μm and 300 μm, in particular of approximately 100 μm.

The polymeric support layer in an ion-permeable membrane is preferably identical in its properties to the polymeric support layer described in the context of our method. Also with respect to the preferred features of the polymeric support layer, reference is explicitly made to the corresponding parts of the description above.

Preferably, the polymer layer is firmly joined to the support layer, in particular, so firmly that it cannot be detached from the support film, at least no longer in a nondestructive manner. The latter applies, in particular, when the polymer layer and the support layer have the same material nature. In particular, in this case, it can be preferred that an interface can no longer be determined between the support layer and the polymer layer and the polymer layer and the support layer form a one-piece composite. The same also applies to the preferred aspects of an ion-permeable membrane in which this has two polymer layers which are joined to one another, each of which on the side facing away from the other has a preferably regular pattern of identically or differently structured elevations and/or recesses.

Particular preference is given to an ion-permeable membrane when it has a polymer layer which comprises a regular pattern of identically structured elevations and recesses.

It is possible that the ion-permeable membrane comprises a polymer layer which has only recesses which form a regular pattern.

It is possible that the ion-permeable membrane comprises a polymer layer which has only elevations which form a regular pattern.

The recesses may form a grid-like or lattice-like pattern. The recesses can preferably be formed in a channel-like manner. Crossing recesses preferably make an angle between 60° and 120°, in particular of approximately 90°.

The recesses preferably have a width between 0.3 mm and 2 mm, in particular between 0.5 mm and 1.2 mm, particularly preferably of approximately 0.8 mm.

Preferably, between the recesses, elevations can be formed preferably having a rhomboidal outline, in particular having an essentially square outline.

The elevations preferably have side lengths between 1 mm and 10 mm, in particular between 3 mm and 8 mm, particularly preferably of approximately 5 mm.

The height of the elevations (starting from the lowest point on the membrane surface) is, in particular, between 0.005 mm and 5 mm.

The depth of the recesses (starting from the highest point on the membrane surface) is, in particular, between 0.005 mm and 5 mm.

It can be particularly preferred that the elevations have edges which are constructed to be higher than the center of the elevations. Between the edges of the elevations a recess, in particular a depression-type recess, having preferably essentially rhomboidal, in particular essentially square, outline, can be formed.

The elevations may form a grid-like or lattice-like pattern. An ion-permeable membrane having such properties is producible, in particular, according to the above-described method in which the shaping element is brought into contact with a polymer film which comprises the at least one polymer in a fraction of 10% by weight to 40% by weight.

Crossing elevations are, in particular, at an angle between 60° and 120°, in particular of approximately 90°.

Preferably, between the elevations, recesses having in particular a rhomboidal, particularly preferably an essentially square, outline are formed.

The elevations have, in particular, a width between 0.3 mm and 2 mm, in particular between 0.5 mm and 1.2 mm, particularly preferably of approximately 0.8 mm.

The recesses have, in particular, side lengths between 1 mm and 10 mm, in particular between 3 mm and 8 mm, particularly preferably of approximately 5 mm.

The height of the elevations is (starting from the lowest point on the membrane surface) preferably between 0.005 mm and 5 mm.

Recesses and elevations constructed in the same direction preferably run in each case strictly parallel to one another and are arranged at preferably regular distances to one another.

In particular, in the production of ion-permeable membranes having two polymer layers which are joined to one another, each of which on the side facing away from the other has a preferably regular pattern of identically or differently structured elevations and/or recesses, and of ion-permeable membranes having a polymer layer which on both sides has a preferably regular pattern of identically or differently structured elevations and/or recesses, the advantages of the method are very clearly exhibited.

Ion-permeable membranes are producible having:
a composite of two polymer layers (1) which are joined to one another, each of which, on the side facing away from the other, has a preferably regular pattern of identically or differently structured elevations and/or recesses, and also
ion-exchange membranes having a polymer layer (2) which on both sides has a preferably regular pattern of identically or differently structured elevations and/or recesses,
   by, in a first step, bringing a shaping element into contact with a first polymer film and then curing the first polymer film. In a second step, the cured, polymer film is used as a support layer and supports on the non-profiled side thereof a second polymer film which is subsequently again profiled and cured. If identical material is used in each case for both polymer films, then, as mentioned above, an interface may no longer be recognizable between the two profiled polymer layers in the composite which is formed (therefore an ion-permeable membrane is obtained having a polymer layer (2)). Otherwise, an ion-permeable membrane is obtained having a composite of two polymer layers (1) joined to one another.

By a similar procedure using a first polymer film situated on a polymeric support layer, in which then the second polymer film is applied to the rear side of the support layer, ion-permeable membranes are obtained having two polymer layers which are joined to one another via the support layer, each of which, on the side facing away from the other, has a preferably regular pattern of identically or differently structured elevations and/or recesses.

Such a procedure is generally not possible using the hot-press molding of membranes known from the prior art, since the (subsequent) hot impressing of a second pattern onto the rear side of a membrane already provided with a first pattern would destroy or at least seriously damage the profile applied first. Also, membranes having a pattern on both sides may be produced wherein the patterns differ from one another.

In addition, a membrane arrangement is also subject matter of this disclosure. It comprises at least one ion-permeable membrane as is described immediately above, for which reason here also reference can be made to the corresponding details.

A membrane arrangement and/or membrane may be a component of a dialysis device, in particular an electrodialysis device.

Membrane arrangements for the electrodialytic desalting generally comprise in each case at least one diluate chamber and one concentrate chamber.

The membrane arrangement may comprise at least two ion-exchange membranes.

In a development of a membrane arrangement, it is preferred that it has at least two ion-permeable membranes between which a separate spacer is arranged. Such an arrangement has proved to be highly advantageous in practice, in particular from hydrodynamic aspects.

As separate spacers, use may be made of, in principle, all known spacers for electrodialysis devices, in particular including those which may be used as a shaping element and have already been described above.

The ion-permeable membranes are suitable not only for dialysis methods and processes, they can in particular also be used in fuel cells, redox flow cells and electrolysis devices. Also, reverse electrodialysis for power generation is a potential field of application for the ion-permeable membranes.

Correspondingly, a membrane arrangement and/or membrane may be a component of a fuel cell.

A membrane arrangement and/or membrane can be a component of a redox flow cell.

Likewise, it can be preferred that a membrane arrangement and/or membrane is a component of an electrolysis device.

This disclosure likewise encompasses a method for the electrodialytic desalting of liquids, wherein at least one membrane arrangement is used. The description above of the membrane arrangement is hereby incorporated by reference.

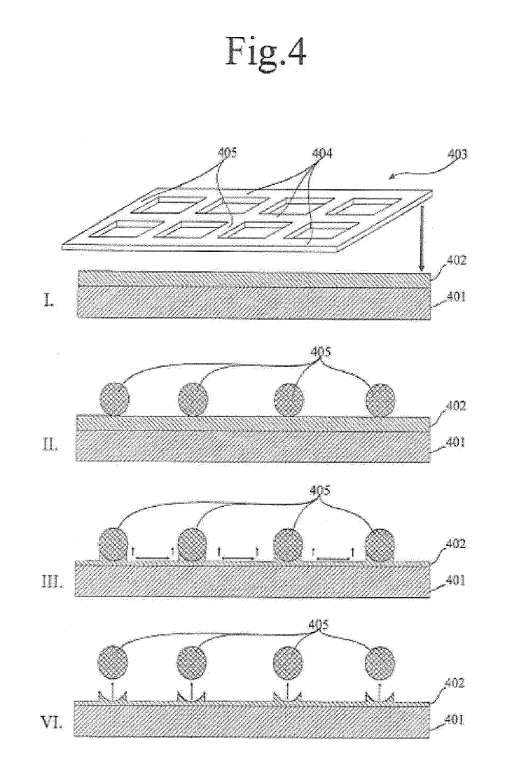

Turning now to the Drawings, FIG. 4 diagrammatically shows the procedure in a particularly preferred method. An uncured polymer film 402 (in the example below the second polymer film) containing at least one polymer is provided on a substrate 401 (in the example below the first polymer film). A flat grid-like or lattice-like structure 403 having filaments as described above having the longitudinal filaments 404 and the transverse filaments 405 is brought into contact in I. with the polymer film 402, more precisely in such a manner that below the filament the at least one polymer can collect (II. shows in cross section transverse filaments 405 brought into contact in this manner with the polymer film 402). Subsequently, solvent and/or dispersant present in the polymer film is removed, for example by allowing it to evaporate. In this process, the at least one polymer collects below the filaments 405 (see III., likewise cross-sectional view). After removal of the solvent, the spacer or the grid-like or lattice-like structure 403 is removed, the resultant elevation on the substrate is shown in IV. (cross-sectional view). On the substrate, particularly advantageously, a positive copy of the structure which is used 403 may be generated.

### Example

### Production of an Ion-Exchange Membrane

The solvent charged was N-methyl-2-pyrrolidone. With stirring, SPEEK and PES were dissolved therein at least in part in a weight ratio of 6:4. The resultant polymer solution had a polymer fraction of 20% by weight.

From the polymer solution, a first polymer film having a thickness of 500 μm (based on the solvent-containing film) was poured. The film was dried until the solvent present in the film had been essentially completely removed. The resultant cured film had a thickness of approximately 100 μm.

Using the above-described polymer solution, a second polymer film was poured in a thickness of 300 μm (again based on the solvent-containing film) onto the dried first film, now acting as support. A flat spacer constructed so as to be grid-like made of filaments arranged crossed which hold it essentially square passages (described in Journal of Membrane Science, 282, 2006, 351-361 as “spacer H”) was lightly pressed onto the second film. The filaments had a diameter of approximately 0.8 mm. The film was dried and subsequently transferred to a water bath together with the spacer which had been continuously pressed on during the drying operation. In the water bath the film was taken off from the spacer.

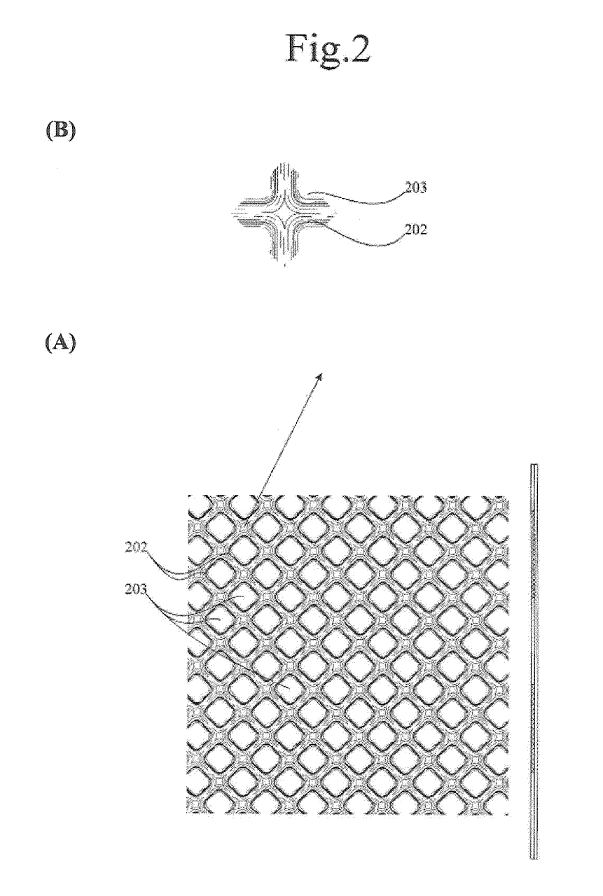

The resultant ion-exchange membrane comprised a support layer and a profiled polymer layer applied thereon, firmly joined to the support layer, and having a regular pattern of identically structured elevations and recesses. The profiled side of the polymer layer is shown in FIGS. 2A and 2B.

In FIGS. 2A and 2B, a multiplicity of essentially identically structured elevations 201 may be seen. The elevations have essentially square outlines, and for improved depiction, in some elevations, these were redrawn with a black pen. The elevations 201 are arranged in rows parallel to one another. All elevations 201 are separated from one another by intersecting, groove-like recesses 200 which are constructed so as to be channel-like, which define a regular grid-like or lattice-like pattern having essentially square interstices (the elevations 201) and thus define the outlines of the elevations 201. Recesses 200 which are arranged in the same direction run parallel to one another in this case and are arranged at regular distances to one another.

The recesses 200 copy the geometry and the extent of the filaments of the spacer used fairly exactly, which can also have been expected. Surprisingly, in FIGS. 2A and 2B, however, it can clearly be seen that within the elevations 201 depression-like recesses 203 are formed. The depression-like recesses 203 are likewise formed in essentially square shape.

Shown in cross section, the elevations 201 therefore have their highest points in the region of their lateral delimitations 202. To the right and left of the lateral delimitations 202 (the outlines of the elevations 201 which are redrawn with a black pen) of an elevation 201 there is situated in each case one of the groove-like recesses 200. Between the lateral delimitations 202 there is the depression-like recess 203, which has its lowest point in the center of the elevation 201. The depression-like recess 203 is preferably constructed so as to be flatter than the groove-like recesses 200.

The groove-like recesses 200 may easily be seen, in particular in the enlarged depiction in FIGS. 2A and 2B. They run centrally through the image from bottom to top or from left to right. In the left upper and lower corner of the picture and also at the right-hand side at the top and bottom, in each case one elevation 201 having an essentially square outline may be seen in sections. In particular, in the case of the elevations on the left at the bottom and on the right at the top, the contour of the lateral delimitations 202 of the elevations is clearly marked, which elevations in each case form the highest points thereof (for improved depiction they have been redrawn with a black pen).

The formation of such a structure is suspected, as already mentioned above, to be due to capillary forces. The polymer solution used for producing the membrane had a polymer fraction of 20% by weight. The at least one polymer was able to accumulate and/or collect on and/or below the filaments, as a result of which the edges and/or lateral delimitations 202 of the elevations 201 formed. Between the forming edges, at the same time, the polymer fraction decreased, as a result of which the depression-like recess mentioned 203 developed.

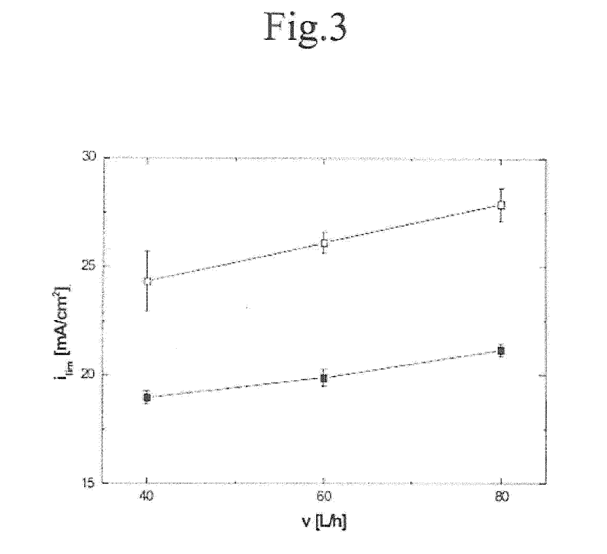

A membrane produced according to the above protocol was installed in a membrane arrangement, with which subsequently test measurements were carried out under conditions as were described by Balster et al. in the Journal of Membrane Science 282 (2006), 351-361. In FIG. 3 some results of these measurements are shown (top curve). What is shown is the course of the limiting current density as a function of flow rate. For comparison, in the bottom curve, the results for a membrane arrangement which differed from ours only in that a non-profiled standard membrane had been installed therein. The measurement conditions were identical.

1-38. (canceled)

39. A method for producing an ion-permeable membrane which has at least one profiled surface comprising:
contacting a shaping element with an uncured polymer film which contains at least one polymer;
impressing the shaping element onto the polymer film; and
generating a regular pattern of identically or differently structured elevations and/or recesses on the polymer film.

40. The method as claimed in claim 39, wherein:
the uncured polymer film is provided on a substrate;
the shaping element is contacted with the polymer film; and
the polymer film is cured.

41. The method as claimed in claim 39, wherein the shaping element is contacted with a solvent- and/or dispersant-containing polymer film in which the at least one polymer is present at least in part in dissolved and/or dispersed form.

42. The method as claimed in claim 40, wherein the uncured polymer film is applied to the substrate in free-flowing form by pouring, spreading or spraying.

43. The method as claimed in claim 39, wherein the shaping element is a grid-like, flat structure made of filaments, and is contacted with the uncured polymer film.

44. The method as claimed in claim 39, wherein the shaping element is a commercially available spacer contacted with the uncured polymer film.

45. The method as claimed in claim 40, wherein the shaping element remains in contact with the polymer film until the polymer film is cured.

46. The method as claimed in claim 41, wherein solvent and/or dispersant present in the polymer film is removed during curing.

47. The method as claimed in claim 40, wherein the uncured polymer film is provided on a polymeric support layer.

48. The method as claimed in claim 47, wherein the support layer has a composition essentially corresponding to that of the cured polymer film.

49. The method as claimed in claim 39, comprising the steps:
applying a solvent- and/or dispersant-containing polymer film, in which at least one polymer is present at least in part in dissolved and/or dispersed form, to a polymeric support layer;
contacting a shaping element with the polymer film and generating a preferably regular pattern of identically or differently structured elevations and/or recesses; and
removing solvent and/or dispersant present in the polymer film.

50. The method as claimed in claim 39, wherein the shaping element is contacted with a polymer film having a thickness between 50 μm and 500 μm.

51. The method as claimed in claim 47, wherein the uncured polymer film is provided on a polymeric support layer which has a thickness between 10 μm and 300 μm.

52. The method as claimed in claim 39, wherein the polymer film comprises a mixture of two or more polymers.

53. The method as claimed in claim 39, wherein the polymer film comprises a sulfonated polyether ether ketone (SPEEK) and/or a polyether sulfone (PES).

54. The method as claimed in claim 39, wherein the uncured polymer film comprises at least one organic solvent.

55. The method as claimed in claim 54, wherein the shaping element is contacted with a polymer film which contains the at least one polymer in a fraction of 10% by weight to 30% by weight.

56. An ion-permeable membrane having a profiled surface, produced by the method of claim 39.

57. The membrane as claimed in claim 56, comprising a polymer layer having a regular pattern of identically or differently structured elevations and/or recesses.

58. The membrane as claimed in claim 57, comprising a support layer on which the polymer layer having eh regular pattern of identically or differently structured elevations and/or recesses is arranged.

59. The membrane as claimed in claim 57, comprising two polymer layers joined to one another, each of which on a side facing away from the other comprises a preferably regular pattern of identically or differently structured elevations and/or recesses.

60. The membrane as claimed in claim 59, wherein the two polymer layers are joined to one another via a support layer which is arranged between the two polymer layers.

61. The membrane as claimed in claim 59, wherein one of the polymer layers is made of a cation-exchange material and the other is made of an anion-exchange material.

62. The membrane as claimed in claim 57, wherein the polymer layer comprises on both sides a regular pattern of identically or differently structured elevations and/or recesses.

63. The membrane as claimed in claim 57, comprising a regular pattern of identically structured elevations and recesses.

64. The membrane as claimed in claim 57, wherein the recesses form a grid-like or lattice-like pattern.

65. The membrane as claimed in claim 64, wherein, between the recesses, elevations are formed which have a rhomboidal outline.

66. The membrane as claimed in claim 65, wherein edges of the elevations are constructed to be higher than the center thereof.

67. The membrane as claimed in claim 66, wherein the elevations form a grid-like or lattice-like pattern.

68. The membrane as claimed in claim 67, wherein, between the elevations, recesses having an essentially rhomboidal outline are formed.

69. The membrane as claimed in claim 68, wherein the polymer layer has a thickness between 10 μm and 300 μm.

70. A membrane arrangement comprising at least one ion-permeable membrane as claimed in claim 56.

71. The membrane arrangement as claimed in claim 70, comprising a component of a dialysis device.

72. The membrane arrangement as claimed in claim 70, comprising at least two ion-permeable, membranes, wherein a separate spacer is arranged between the membranes.

73. The membrane arrangement as claimed in claim 70, comprising a component of a redox flow cell.

74. The membrane arrangement as claimed in claim 70, comprising a component of a redox flow cell.

75. The membrane arrangement as claimed in claim 70, comprising a component of an electrolysis device.

76. A method for electrodialytic desalting of liquids comprising passing the liquids through at least one membrane arrangement as claimed in claim 70.
